(19) United States
(12) Patent Application Publication
(10) Pub. No.: US 2009/0229189 A1
(43) Pub. Date: Sep. 17, 2009

(54) METHOD FOR PREPARING A POLISHING SLURRY HAVING HIGH DISPERSION STABILITY

(75) Inventors: Yun Ju CHO, Suwon-si (KR); In Yeon LEE, Seoul (KR); Hoon Soo JEON, Suwon-si (KR); Duk Young HONG, Suwon-si (KR); Taiyoung KIM, Suwon-si (KR); Sangick LEE, Suwon-si (KR); Eunkyoung PARK, Suwon-si (KR)

Correspondence Address: Baker & Hostetler LLP;Attn: Jim Coffman, 45 Rockefeller Plaza, New York, NY, 10111, US

(73) Assignee: SAMSUNG CORNING CO., LTD.

(21) Appl. No.: 12/464,955

(22) Filed: May 13, 2009

Related U.S. Application Data
(63) Continuation of application No. 11/389,396, filed on Mar. 24, 2006.

(30) Foreign Application Priority Data
Mar. 28, 2005 (KR) 10-2005-0025496
Aug. 19, 2005 (KR) 10-2005-0076021

(51) Int. Cl. C09K 3/14

(52) U.S. Cl. 51/298

(57) ABSTRACT

The present invention relates to an improved method for preparing a polishing slurry, comprising dispersing polishing particles and an anionic polymeric acid in water and then adding to the resulting dispersion an alkaline material in an amount of 0.1 to 8 weight parts based on 100 weight parts of the polishing particles. The polishing slurry obtained by the inventive method exhibits good dispersion stability and non-Prestonian polishing performance, which can be beneficially employed in chemical mechanical polishing of various precision electronic devices.

### FIELD OF THE INVENTION

The present invention relates to a method for preparing a polishing slurry having a high dispersion stability, is suitable for precision chemical mechanical polishing.

### DESCRIPTION OF THE PRIOR ART

Chemical mechanical polishing (CMP) has been used for high precision polishing demanded in precision electronic processes such as semiconductor productions. The CMP process can be conducted using a polishing slurry alone or with a chemical solution selected for achieving desired performance characteristics which are affected by factors such as the size, shape and dispersion stability of the polishing particles. The dispersion stability of polishing particles, particularly, is important because the aggregation of polishing particles leads to the formation of scratches in the course of CMP.

Conventionally, in order to enhance the dispersibility and stability of a polishing slurry, dispersants such as ammonium polymethacrylate, sodium dodecylsulfate and sodium salts of monoalkylphosphate fatty acid are added to the slurry. Although such salts dissociate easily in an aqueous medium, they do not adsorb on the surface of polishing particles in a satisfactory manner because of their steric bulk, leading to particle agglomeration. Such a phenomenon becomes more pronounced when the CMP process is conducted using an added chemical solution.

Another performance characteristic required of CMP is a non-Prestonian behavior, not the Prestonian behavior observed for conventional polishing slurries; the polishing rate is linearly dependent on the polishing pressure. In a non-Prestonian slurry, the slope of the polishing rate measured as function of the pressure suddenly increases when the pressure exceeds a critical point. To obtain such a non-Prestonian slurry, various additives have been tested, but such efforts have not, thus far, significantly improved the dispersion stability of the slurry.

### SUMMARY OF THE INVENTION

It is, therefore, an object of the present invention to provide a method for preparing a polishing slurry having an improved dispersion stability, which exhibits non-Prestonian polishing performance characteristics.

In accordance with one aspect of the present invention, there is provided a method for preparing a polishing slurry, which comprises the steps of
(a) dispersing polishing particles and an anionic polymeric acid dispersant in water; and
(b) adding to the resulting dispersion an alkaline material in an amount of 0.1 to 8 weight parts based on 100 weight parts of the polishing particles.

In accordance with another aspect of the present invention, there is provided a polishing slurry prepared by said method to exhibit an improved dispersion stability and non-Prestonian polishing performance characteristics.

### BRIEF DESCRIPTION OF THE DRAWINGS

The above and other objects and features of the present invention will become apparent from the following description of the invention taken in conjunction with the accompanying drawings, which respectively show:

FIG. 1: a schematic block diagram illustrating the method for preparing a polishing slurry in accordance with an embodiment of the present invention;

FIG. 2: a schematic view showing one of the CMP processes conducted by using the polishing slurry prepared by the method of the present invention; and

FIG. 3: a graph showing the polishing rate-pressure correlations obtained for a Prestonian slurry (a conventional polishing slurry) and the non-Prestonian slurry of the present invention.

### DETAILED DESCRIPTION OF THE INVENTION

The inventive process for preparing a polishing slurry is characterized by treating polishing particles dispersed in water containing an anionic polymeric acid dispersant with an alkaline material.

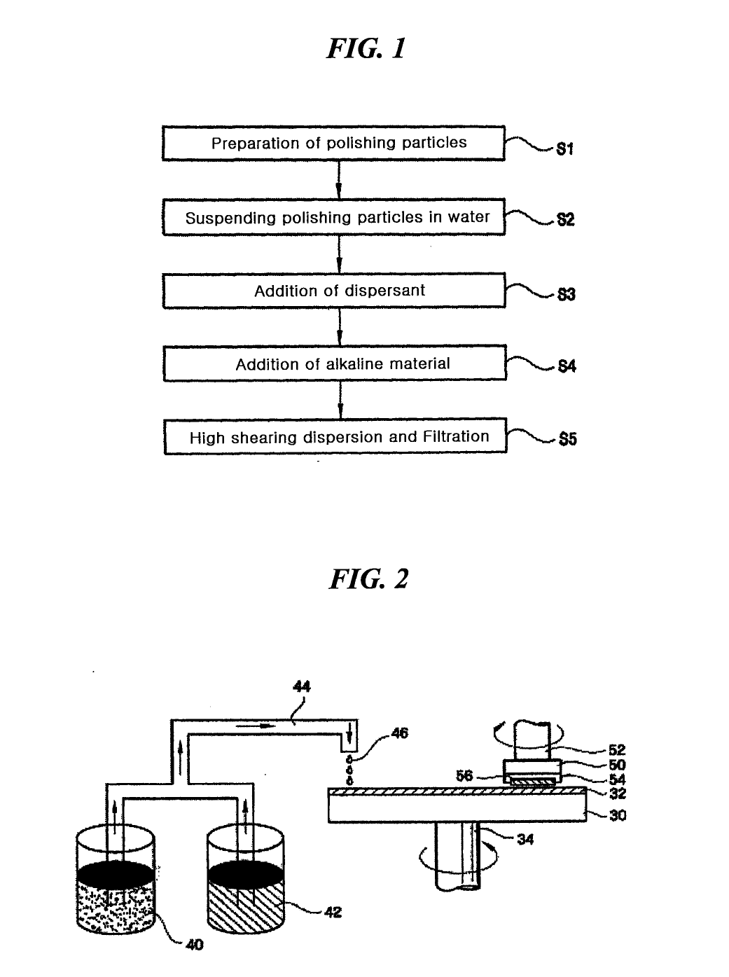

FIG. 1 schematically shows an embodiment of the present invention. First, polishing particles are prepared (S1) and suspended in water (S2), and an anionic polymeric acid as a dispersant is added thereto (S3). Thereafter, the resulting dispersion is treated with an alkaline material (S4), subjected to a high-pressure condition for uniform dispersion, and the resulting material is filtered (S5) to obtain a polishing slurry having large particles removed therefrom. If desired, the polishing particles may be suspended in water, together with the dispersant.

The polishing particles which may be used in S1 include a metal oxide such as silica (SiO₂), alumina (Al₂O₃), ceria (CeO₂), zirconia (ZrO₃), tin oxide (SnO₂) and manganese oxide (MnO₂). Among these, ceria (cerium oxide) is preferred because of its high selectivity of an oxide layer to a nitride layer in a CMP process. Such cerium oxide may be prepared by calcining a cerium carbonate or cerium hydroxide precursor at a temperature of 600 to 1000° C. to generate a cerium oxide powder and milling the powder to an average size of 10 to 100 nm. The milling process may be conducted by a wet or dry method. The polishing particles may be used in an amount of 0.5 to 20 wt % based on the total weight of the polishing slurry.

The suspending step of S2 may be conducted by a conventional method, e.g. agitating, wet-milling, ultrasonic wave treatment, high-pressure dispersion, etc.

Thereafter, in accordance with the present invention, the polishing particles are first treated with an anionic polymeric acid dispersant (S3) and then post-treated with an alkaline material (S4) to confer thereon an enhanced dispersion stability.

The dispersant is to be selected based on the zeta potential of the polishing particle which depends on the pH change in an aqueous medium. For example, when the polishing particles are made of cerium oxide, the cerium oxide, when dispersed in water, exhibits a pH in the range of 4 to 8 and a positive zeta-potential on the surface thereof. Therefore, when an anionic polymeric acid is added as a dispersant to a cerium oxide suspension, a large amount of the dispersant would adsorb on cerium oxide particles in an aqueous medium, due to the attractive electrostatic force generated negative charge which is different from that of cerium oxide, at a pH of 1 to 4.

Then, when the alkaline material is added to the resulting dispersion to adjust the pH of the slurry to a range of 6 to 9, the dispersion stability of the slurry is enhanced. A slurry having enhanced dispersion stability can used for CMP with minimal generation of scratches, even when it is used together with other chemical solutions.

Finally, the slurry obtained above is subjected to high-pressure dispersion and filtration (S5) steps to obtain the inventive polishing slurry.

In the present invention, it is preferred that the alkaline material is used in an amount of 0.1 to 8 weight parts based on 100 weight parts of the polishing particles used. When the amount of the alkaline material is less than 0.1 weight parts, the dispersion stability of the slurry becomes insufficient, and when higher than 8 weight parts, the slurry dispersion becomes unstable.

The alkaline material used in the present invention may be selected from the group consisting of ammonia, an alkylammonium salt, an amine and a mixture thereof. The amine may be selected from the group consisting of trimethanolamine, triethanolamine, dimethylbenzylamine, ethoxybenzylamine and a mixture thereof. The alkylammonium salt may be selected from the group consisting of trimethylammonium hydroxide, triethylammonium hydroxide, tetramethylammonium hydroxide, choline and a mixture thereof.

The anionic polymeric acid used as a dispersant in the present invention is preferred to have a weight-average molecular weight of 2,000 to 250,000, more preferably 2,000 to 100,000, and it may be selected from the group consisting of polymethacrylic acid, polyacrylic acid, polyvinylsulfonic acid and a mixture thereof. When the molecular weight is less than 2,000, the dispersibility of the slurry becomes insufficient, and when higher than 250,000, the long-term stability of the slurry becomes unsatisfactory due to the increased viscosity of the slurry.

The anionic polymeric acid may be used in an amount of 0.1 to 10 weight parts based on 100 weight parts of the polishing particles used. When the amount of the anionic acid is less than 0.1 weight parts, the dispersibility of the slurry becomes insufficient, and when higher than 10 weight parts, the long-term stability of the slurry becomes poor.

So as to enhance the dispersion of the polishing particles, agitating may be performed for 10 to 90 minutes, preferably 30 to 60 minutes, after each of the steps of adding a dispersant and an alkaline material.

If necessary, the polishing slurry prepared according to the inventive method may be diluted by the addition of water to a desired concentration.

Also, the inventive method may further comprise adding other conventional additives to the polishing slurry. For example, a preservative for long-term storage of the slurry, e.g., 5-chloro-2-methyl-4-isothiazoline-3-on and 2-methyl-4-isothiazoline-3-on, may be added in an amount of 0.01 to 0.5 wt % based on the total weight of the slurry.

Furthermore, the present invention provides a polishing slurry prepared by the inventive method as mentioned above, which comprises polishing particles having an average size of 100 to 500 nm. This inventive slurry is characterized by its good dispersibility and long-term dispersion stability, resistant to the aggregation of the polishing particles, as well as by its non-Prestonian polishing performance. For example, even when the inventive slurry is used together with other chemical solutions in CMP, the size of the polishing particles does not change significantly over a long period of time.

Also, the inventive polishing slurry has a pH ranging 6 to 9 so that it is more selective in polishing a target layer (e.g., an oxide layer) over a polishing stopper (e.g., a nitride layer). This is due to the fact that an oxide layer generally has an isoelectric point (IEP) at a pH of 2 to 4 while a nitride layer, a pH of 5 to 6. Accordingly, the inventive slurry can be advantageously used in a CMP process for shallow trench isolation (STI), interlayer dilelectric (ILD) or intermetal dielectric (IMD) formation.

The present invention will be described in further detail with reference to Examples. However, it should be understood that the present invention is not restricted by the specific Examples.

### Example 1

Cerium oxide obtained by calcining cerium carbonate at 900° C. was finely pulverized using a dry ball mill. 1000 g of the pulverized cerium oxide was poured in 8910 g of distilled water and the resulting mixture was agitated using a propeller-type agitator for 30 minutes. 30 g of 50 wt % polyacrylic acid (weight-average molecular weight: 5,000) as a dispersant was added to the resulting suspension and the resulting mixture having pH 3 was stirred for 30 minutes. Thereto, 60 g of 25 wt % tetramethylammonium hydroxide as an alkaline material was added and the resulting mixture having pH 8.3 was stirred for 30 minutes. The resultant was subjected to high-pressure dispersion and filtered through CMP3 filter (Mykrolis Corp.) to remove large particles. The filtrate was diluted with distilled water to obtain a 5 wt % cerium oxide slurry.

### Example 2

The procedure of Example 1 was repeated except that 8902.5 g of distilled water was used in the agitating procedure of the pulverized cerium oxide and 37.5 g of 40 wt % polyacrylic acid (weight-average molecular weight: 15,000) was used as a dispersant, to obtain a cerium oxide slurry (pH 8.2).

### Example 3

The procedure of Example 1 was repeated except that 8920 g of distilled water was used in the agitating procedure of the pulverized cerium oxide and 50 g of 30 wt % aqueous ammonia was used as an alkaline material, to obtain a cerium oxide slurry (pH 8.5).

### Comparative Example 1

The procedure of Example 1 was repeated except that the alkaline material was added to the cerium oxide suspension before the addition of the dispersant, to obtain a cerium oxide slurry (pH 3).

### Comparative Example 2

The procedure of Example 1 was repeated except that a mixture of the dispersant and the alkaline material was added to the cerium oxide suspension, to obtain a cerium oxide slurry (pH 12).

### Comparative Example 3

The procedure of Example 1 was repeated except that the dispersant and the alkaline material were added simultaneously to the cerium oxide suspension, to obtain a cerium oxide slurry (pH 8.2).

### Comparative Example 4

The procedure of Example 1 was repeated except that 8962.5 g of distilled water was added in the agitating procedure of the pulverized cerium oxide and 37.5 g of 40 wt % ammonium polyacrylate (weight-average molecular weight: 3,000) as a dispersant was added to the cerium oxide suspension without the addition of an alkaline material, to obtain a cerium oxide slurry (pH 8.3).

### Comparative Example 5

The procedure of Example 1 was repeated except that the amount of 25 wt % tetramethylammonium hydroxide used as an alkaline material was reduced to 2 g, from 60 g, to obtain a cerium oxide slurry (pH 3.8).

### Comparative Example 6

The procedure of Example 1 was repeated except that the amount of 25 wt % tetramethylammonium hydroxide used as an alkaline material was increased to 400 g, from 60 g, to obtain a cerium oxide slurry (pH 12.8).

### Experimental Example 1

### Measurement of Adsorption Degree of Dispersant to Polishing Particles

Equal amounts of the 5 wt % cerium oxide slurries obtained in Examples 1 to 3 and Comparative Examples 1 to 6 were taken, and each was subjected to centrifugation at 4,000 rpm for 20 minutes to collect cerium oxide particles, which were dried at 90° C. and analyzed for their carbon content using a carbon analyzer, to evaluate the amount of the dispersant adsorbed to the particles. The results are shown in Table 1.

TABLE 1

| | Carbon content in slurry |
|---|---|
| | (wt %) |
| Ex. 1 | 0.403 |
| Ex. 2 | 0.526 |
| Ex. 3 | 0.485 |
| Com. Ex. 1 | 0.196 |
| Com. Ex. 2 | 0.182 |
| Com. Ex. 3 | 0.115 |
| Com. Ex. 4 | 0.184 |
| Com. Ex. 5 | 0.065 |
| Com. Ex. 6 | 0.287 |

As shown in Table 1, the slurries of Examples 1 to 3 have higher carbon content, (i.e., the amount of the organic dispersant adsorbed in the cerium oxide particles) than the slurries of Comparative Examples 1 to 6, which suggests that the inventive slurries have better dispersion stability.

### Experimental Example 2

### Polishing Performance Test

The cerium oxide slurries obtained in Examples 1 to 3 and Comparative Examples 1 to 6 were each subjected to CMP using AMAT Mirra polisher as shown in FIG. 2, to evaluate its polishing performances.

The polisher was equipped with a platen (30) for CMP having a polishing pad (32) on the surface thereof which was rotated around axis (34), and with a head (50) for CMP having a wafer (56) detachably attached thereto using a clamp (54), which was rotated around axis (52). As the polishing pad, an IC1000/suva IV stacked pad (Rodel Inc.) was used. As test wafers, an 8″ silicon wafer coated with a 10,000 Å thick PE-TEOS oxide film by plasma enhanced-chemical vapor deposition and another 8″ silicon wafer coated with a 2,000 Å thick silicon nitride film by low pressure chemical vapor deposition were used.

To conduct CMP, as shown in FIG. 2, each of the cerium oxide slurry to be tested was mixed with distilled water in the mix ratio of 1:3 in a supplying part (40), and a chemical solution was prepared by dissolving 2,000 g of ammonium polymetacrylate (M. W. 15,000) and 200 g of tartaric acid in 7,800 g of distilled water and stirring the resulting solution for 30 minutes in a second supplying part (42). Then, the test cerium slurry and the chemical solution were mixed in the mix ratio of 4:3, transferred through a channel (44) and supplied from an outlet (46) on the pad (32) which was in contact with the wafer (56), while the platen (30) and the head (50) were rotated in opposite directions from each other for 90 seconds under the polishing conditions of 3.5 psi applied pressure, platen-rotating rate of 80 rpm and head-rotating rate of 28 rpm.

The polished films was then examined for its thickness with Ellipsometer (Philips) to determine the polishing rate thereof and for scratches having a size of at least 0.16 μm with AIT-01 wafer inspection system (KLA Tenco). The results are shown in Table 2.

TABLE 2

| | | | Polishing ratio | |
|---|---|---|---|---|
| | Polishing rate | Polishing rate of | of oxide film: | |
| | of oxide film | niride film | nitride film | The numbers |
| | (Å/min.) | (Å/min.) | (Selective ratio) | of scratches |
| Ex. 1 | 3586 | 126 | 28.5 | 8 |
| Ex. 2 | 3722 | 142 | 26.2 | 9 |
| Ex. 3 | 3542 | 105 | 33.7 | 11 |
| Com. Ex. 1 | 3254 | 117 | 27.8 | 36 |
| Com. Ex. 2 | 3025 | 129 | 23.5 | 49 |
| Com. Ex. 3 | 3159 | 124 | 25.5 | 66 |
| Com. Ex. 4 | 3355 | 131 | 25.6 | 42 |
| Com. Ex. 5 | 1523 | 98 | 15.5 | 132 |
| Com. Ex. 6 | 2568 | 369 | 7.0 | 94 |

As shown in Table 2, the use of the slurries of Examples 1 to 3 generated much less scratches as compared with the slurries of Comparative Examples 1 to 6, although the tested slurries show similar levels of selectivity.

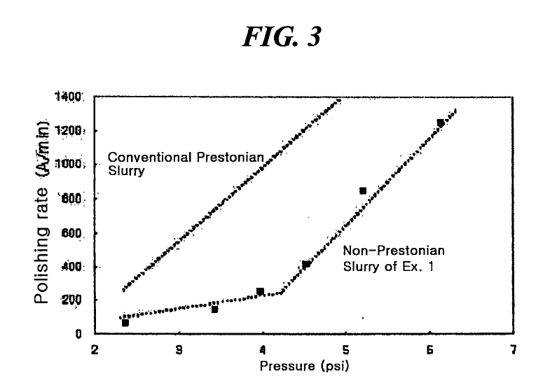

Also, the cerium oxide slurry obtained in Example 1 was subjected to CMP while varying the pressure applied, and the polishing rate was determined by using Ellipsometer (Philips) and thermawave OPTI Prove-2600 (Vintage). As shown in FIG. 3, the cerium oxide slurry obtained in Example 1 exhibited a non-Prestonian behavior; the polishing rate was not linearly dependent on the polishing pressure but increased abruptly at pressures above a critical point.

### Experimental Example 3

### Dispersion Stability Test after Mixing with a Chemical Solution

The cerium oxide slurries used in Experimental Example 2 were each evaluated for its dispersion stability by the following procedures, and the results are listed in Table 3.

### (1) Analysis of Particle Size Change

Each of the cerium oxide slurry-chemical solution mixtures used in Experimental Example 2 was sampled at the outlet (46), and the particle size of cerium oxide was determined with MICROTRAC UPA 1500, which was compared with the particle size before mixing with the chemical solution.

### (2) Observation of Particle Precipitation Degree

50 ml of each of the cerium oxide slurry-chemical solution mixtures used in Experimental Example 2 was sampled from the outlet (46) and placed in a cylinder. At 2 and 6 hour of standing, the degree of precipitation of particles was visually observed to determine the turbid degree of the slurry mixture (◯ totally turbid, good dispersibility; Δ clarity in the supernatant; X totally clear, extensive precipitation).

TABLE 3

| | Particle size change | | Particle precipitation | |
|---|---|---|---|---|
| | Before mixing | After mixing | degree | |
| | (nm) | (nm) | 2 hours | 6 hours |
| Ex. 1 | 191.2 | 216.7 | ◯ | ◯ |
| Ex. 2 | 220.3 | 245.6 | ◯ | ◯ |
| Ex. 3 | 203.6 | 238.5 | ◯ | ◯ |
| Com. Ex. 1 | 212.9 | 1940.3 | Δ | X |
| Com. Ex. 2 | 256.3 | 2898.0 | Δ | X |
| Com. Ex. 3 | 242.3 | 2650.2 | Δ | X |
| Com. Ex. 4 | 180.6 | 1737.5 | Δ | X |
| Com. Ex. 5 | 1286.3 | 3675.5 | X | X |
| Com. Ex. 6 | 215.6 | 2392.5 | X | X |

As shown in Table 3, after mixing with a chemical solution, the slurries of Comparative Examples 1 to 6 generated extensively agglomerated particles having particle sizes that were more 9 times than the initial size, while the slurries of Examples 1 to 3 exhibited good dispersion stability without any sign for particle aggregation.

### Experimental Example 4

### Long-Term Dispersion Stability Test

30 ml of each of the cerium oxide slurries of Example 1 and Comparative Example 1 and 2 was placed in a 40 ml cylinder, and after 10, 60 and 90 days storage, subjected to the CMP procedure of Experimental Example 2 to determine the polishing rate change after such long-term storage. The results are shown in Table 4.

TABLE 4

Polishing rate change (Å/min.)

| | Initial | 10 days | 60 days | 90 days |
|---|---|---|---|---|
| Ex. 1 | 3586 | 3614 | 3525 | 3550 |
| Com. Ex. 1 | 3254 | 3003 | 2500 | 2200 |
| Com. Ex. 2 | 3025 | 2600 | 2158 | 1985 |

As shown in Table 4, the inventive slurry maintained its dispersion stability for 90 days as witnessed by the result of polishing rate change, while the slurries of Comparative Examples 1 and 2 exhibited the declined polishing rates, suggesting that they are less stable.

While the invention has been described with respect to the specific embodiments, it should be recognized that various modifications and changes may be made by those skilled in the art to the invention which also fall within the scope of the invention as defined as the appended claims.

1. A method for preparing a polishing slurry, which comprises the steps of
(a) dispersing polishing particles and an anionic polymeric acid dispersant in water;
(b) agitating or stirring the mixture for sufficient time to enhance dispersion with the dispersant fully absorbed on the polishing particles; and
(c) following step (b), adding to the resulting dispersion an alkaline material in an amount of 0.1 to 8 weight parts based on 100 weight parts of the polishing particles.

2. The method of claim 1, wherein the polishing particles dispersed in step (a) have a positive zeta potential on the surface thereof.

3. The method of claim 1, wherein the dispersion obtained in step (a) has a pH ranging from 1 to 4.

4. The method of claim 1, wherein the polishing slurry has a pH ranging from 6 to 9.

5. The method of claim 1, wherein the polishing particles consist of a metal oxide selected from the group consisting of silica (Sᵢ0₂), alumina (Al₂0₃), ceria (Cₑ0₂), zirconia (Zᵣ0₃), tin oxide (Sₙ0₂) and manganese oxide (Mₙ0₂).

6. The method of claim 5, wherein the polishing particles are ceria obtained by calcining cerium carbonate or cerium hydroxide at a temperature of 600 to 1000° C.

7. The method of claim 1, wherein the polishing particles are used in an amount of 0.5 to 20 wt % based on the total weight of the polishing slurry.

8. The method of claim 1, wherein the anionic polymeric acid has a weight-average molecular weight of 2,000 to 250,000.

9. The method of claim 1, wherein the anionic polymeric acid is selected from the group consisting of polymethacrylic acid, polyacrylic acid, polyvinylsulfonic acid and a mixture thereof.

10. The method of claim 1, wherein the anionic polymeric acid is used in an amount of 0.1 to 10 weight parts based on 100 weight parts of the polishing particles.

11. The method of claim 1, wherein the alkaline material is selected from the group consisting of ammonia, an alkylammonium salt, an amine and a mixture thereof.

12. The method of claim 11, wherein the amine is selected from the group consisting of trimethanolamine, triethanolamine, dimethylbenzylamine, ethoxybenzylamine and a mixture thereof.

13. The method of claim 11, wherein the alkylammonium salt is selected from the group consisting of trimethylammonium hydroxide, triethylammonium hydroxide, tetramethylammonium hydroxide, choline and a mixture thereof.

14. (canceled)
